(19) United States
(12) Patent Application Publication
(10) Pub. No.: US 2013/0009459 A1
(43) Pub. Date: Jan. 10, 2013

(54) CONNECTING DEVICE FOR CONNECTING ELECTRICAL POWER SUPPLY LINES OF DRILLING AND PRODUCTION FACILITIES

(75) Inventors: Anton Scheibelmasser, Graz (AT); Abdelrhani Lamik, Leoben (AT); Bouchra Lamik-Thonhauser, St. Peter-Freienstein (AT); Werner Lindner, Kapfenberg (AT); Robert Karpf, Bruck/Mur (AT)

(73) Assignee: ADVANCED DRILLING SOLUTIONS GMBH, LEOBEN (AT)

(21) Appl. No.: 13/578,329

(22) PCT Filed: Feb. 3, 2011
(86) PCT No.: PCT/AT11/00062

§ 371 Date: Sep. 19, 2012

(30) Foreign Application Priority Data
Feb. 11, 2010 (AT) A 199/2010

(51) Int. Cl. H04B 3/54

(52) U.S. Cl. 307/1

(57) ABSTRACT

A connecting device, for example, a plug (1) for connecting electrical power supply lines (3), includes a connection (4a) for feeding electrical signals representing the operating state of an electrical, mechanical, hydraulic, or optical device into the power supply line (3). The use of such a connecting device in drilling and production facilities is also described.

The invention relates to a connecting device for connecting electrical power supply lines.

The invention is used preferably in connections of electrical supply lines for drilling and production facilities, for example in a drill hole, on a pipe string or a delivery pipe, or quite generally for underground systems for automated state detection.

One important element in modern petroleum, natural gas and geothermy wells is the detection of the states of units that are relevant to the drilling process. The same, however, also applies to the subsequent petroleum, gas or hot water production after the drilling process is completed. Both on land and offshore, drilling or a producing drill hole can be efficiently and economically operated only by detecting the respective relevant state variables of the units [for example, pumps (electrical submersible pump, sucker rod pump), hoisting gear, motors]. One problem does arise, however, in the acquisition of data from units that are typically not connected to the conventional measurement data acquisition because only their action is measured, but not the state (for example, pressure of a pump, but not the power consumption or the power factor). Thus, it is detected that there is no pressure, but not the cause of the failure (faults in the pressure line or defect of the pump or power outage). The desired acquisition of data is limited in most cases to the detection of the state (ON/OFF) or voltage and current measurements. By the drilling rig-wide detection of these states, downtimes on drilling rigs can be reduced and economic efficiency can be increased.

Currently, on drilling rigs, the measurement data of companies that are independent of one another are detected in their context (for example, mud logger, driller, geologists). The data acquisition is restricted to the measurement quantities that are necessary for the respective drilling rig business. Central, continuous acquisition of data is not done. The monitoring of auxiliary units and their states is only done to a limited degree by conclusions about involved units being drawn indirectly by failure/deviation of a measured quantity. A qualified report about the faulty unit or prior warning with respect to an incipient failure does not exist.

The data transmission technology is often implemented by data links that are installed in a rough environment (for example, a region at risk of explosion). Due to severe ambient conditions (mechanical, thermal, chemical load), only high-grade cables in complex installation are allowed.

The intention to continuously detect the states of units on the drill hole encounters several problems at the same time:
Units whose state is to be detected must be wired or retrofitted with mechanically stable data cables that are also resistant to heat and chemicals.
Drilling rigs are generally transported to new drilling sites at an interval of a few weeks. The dismantling of the cabling and the installation of the cabling at the new site should take place in as short a time as possible.
Measurement data acquisition of the state data of units is currently a not yet perfected field. Conventional data acquisition technology is too expensive for this use.
Central acquisition of data for these unit data is currently not available at the drilling rig. The object of the invention is to be able to detect the state of units on the drill hole as easily as possible.

This object is achieved with a connecting device of the initially-named type in that the connecting device has a connection for the feed of electrical signals that represent the operating state of an electrical, mechanical, hydraulic or optical device into the power supply line.

Preferred and advantageous embodiments of the invention are the subject matter of the dependent claims.

The invention is based on the circumstance that all units to be detected are supplied with network voltage via a power supply line. This power supply line can be used according to the invention to transmit electrical signals that represent the operating state of a device or one of the units that were mentioned above by way of example.

If at this point the electrical network is connected to a carrier frequency system, it is possible to exchange data via the voltage supply lines without having to install additional data lines.

Preferably, the signals or data are fed using a carrier frequency system in which a narrowband OFDM (orthogonal frequency division multiplex, multi carrier) method is used. This method is also known under “Power Line Communication (PLC).” Modems that use this method are currently used in electrical energy networks for remote maintenance or remote reading of meters (distributed line communication, DLC). Thus, over conventional power supply lines without additional cabling, information can be exchanged over several kilometers without repeaters with data rates of several hundred kilobaud.

Thus, the invention preferably makes available a system for central detection of states of distributed units or devices on the drill hole during drilling, completion and production using PLC.

The modem and/or the microcontroller and/or the measurement device are preferably located in housings that can be easily retrofitted in the form of commercially available or slightly modified plugs, sockets or couplings (instrumented connectors).

With the invention, it is possible to devise a measurement system consisting of a PLC modem, microcontroller, data acquisition (sensors) and control (actuators) that is supplied with current via the power cables or that communicates via the power cables with the central data acquisition.

The system according to the invention can measure, for example, current, voltage, frequency, and phase shift between current and voltage, and based on these quantities computes unit states that have been derived from them.

The system according to the invention can set up a data network based on a bus topology over the power cables. In this network, nodes that can be addressed by means of master/slave communication methods on the connecting devices according to the invention are evaluated.

The system according to the invention also makes it possible, when it is executed bidirectionally, to change units in their operating state via remote access (for example, on/off or altered mode).

In particular, it is possible to proceed as follows in embodiments of the invention:

Using modems, the state data of the respective unit or of the respective device are modulated onto its power supply line and supplied to central data acquisition in the power network of the unit. Several of these unit modems are interconnected in a bus topology in this voltage supply network and are connected to the central data circuit by means of a master/slave communications method.

In order to implement simple retrofitting in the field, different housing variants for the installation of the unit modem are proposed:
Modem installation in the electrical receptacle (single-phase or multi-phase receptacle).
Modem installation in an electrical coupling (single-phase or multiphase coupling).
Modem installation in an electrical splitting box or an electrical switchgear cabinet.
Modem installation in a pressure-tight housing that is protected from explosion.

Depending on the plug system of the drilling rig (country-specific, performance-specific), the corresponding plug, receptacle or sockets or couplings are mounted on the outgoing cables. On the housing or on additional outgoing control lines, there are sockets for the feed of sensor data or connections for control of the units. Preferably, this data acquisition unit and/or control unit is installed by inserting this coupling into the power supply line close to the unit.

For electrical couplings/plugs, preferably existing commercially available housings or slightly modified housings (instrumented plugs & sockets) are used. Since the feed or tapping of measurement and control data are integrated into the electrical couplings/plugs, the safety criteria that are to be satisfied for the respective application are also automatically satisfied and no additional safety measures are necessary.

The modem that is connected to a microcontroller circuit is on the electronic circuit board that is located in the respective housing. Modem and microcontroller can also be integrated on a chip. The microcontroller (bus subscriber with distinct address) sends its data in a digital protocol (for example, Modbus) at the request of the master (central data acquisition).

The data are acquired by the microcontroller by means of its I/O units (for example, ADC, SPIBus, ports) by its measuring defined electrical quantities. The following variants of measurement, data evaluation and/or control or any combination of these variants that are named by way of example can be implemented within the framework of the invention:
In the simplest case, this is the on/off state that is determined by, for example, current measurement (Hall sensor).
By current and voltage measurement, the power can be determined, or by a phase measurement between current and voltage, the power factor can be determined, or by the product, the current power can be determined, or by integration, the energy can be determined.
By means of frequency measurement, a conclusion about the speed of a motor and, by current measurement, about the torque can be drawn. Thus, a distributed energy monitoring system is produced on the rig.
High-frequency measurement of the current or computation of the frequency spectrum makes it possible to draw conclusions about load cases and faults or anomalies in the unit that become apparent in the current form.
Additional sensor data that represent the operating states or data of the consumers or of the vicinity of the unit, for example in the form of 4-20 mA or 0-30 V signals, can be fed by (additional) process inputs on the microcontroller or on the housing.
States such as, for example, vibration, pressure, power consumption, etc., can be detected by sensors on the units. Downtimes on the drilling rigs can be reduced and the economic efficiency can be increased by the drilling rig-wide detection of these states.
The combination of existing sensor data and these new state data makes it possible to develop algorithms (state analysis/process analysis) that expand reports about the quality of the drilling process by their also taking into account the drilling rig equipment.
Alternatively, distributed actuators on the units are also possible by means of this method, i.e., groups of units can be centrally turned on and off, for example by means of PLC, or can be changed in their operating state (mode switch) (for example, motor speed, lights, etc). In this way, consumers can be turned on and off, and energy management can be implemented in a dedicated manner.

The energy for supply of the modem and of the connected electronics can be taken from the supply network.

Further details and features of the invention will become apparent from the following description of preferred embodiments with reference to the drawings. Here:

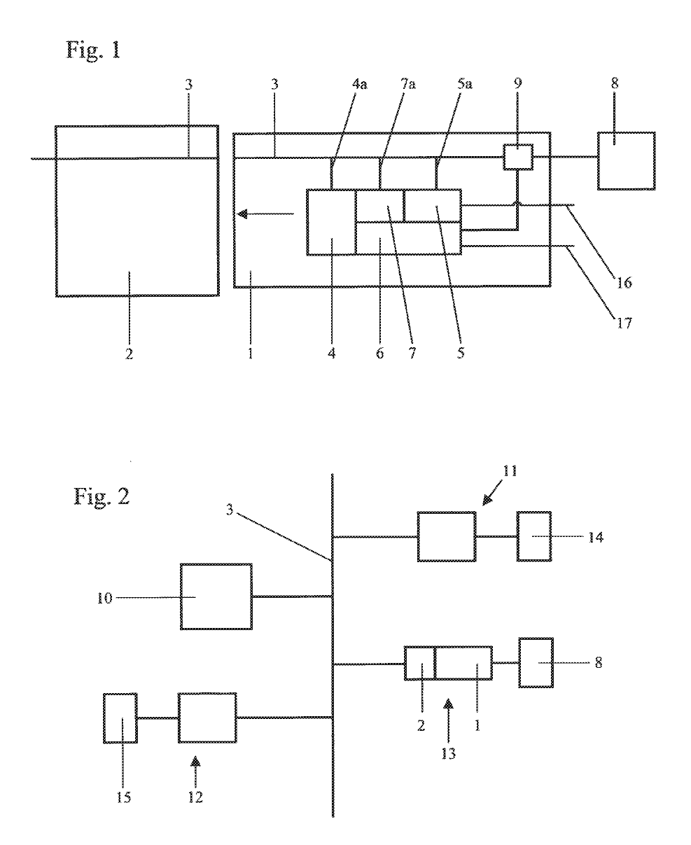

FIG. 1 shows a block diagram of an embodiment of a connecting device according to the invention, and

FIG. 2 shows different consumers that are connected to a central data acquisition system in a power line network.

In the block diagram that is shown in FIG. 1, one embodiment of a connecting device according to the invention in the form of a plug 1 is shown. A PLC modem 4 via one connection 4a and a circuit 5 for data acquisition via one connection 5a are connected to a power supply line 3 (for example, 240/400 V) in the plug 1, which can be plugged onto a power source in the form of a receptacle or socket 2. Furthermore, there is a microcontroller 6 in the plug 1, especially on a circuit board. The PLC modem 4, the circuit 5 and the microcontroller 6 are supplied with current via a connection 7a and a circuit 7.

A consumer 8 who is supplied with electric power is connected to the line 3. In the line 3, an on/off switch 9 that is triggered by the microcontroller 6 is connected upstream from the consumer 8.

Measurement data of the circuit 5 are sent via the microcontroller 6 and the PLC modem 4 over the power supply line 3 and the receptacle 2 to a central data acquisition device that is not shown in FIG. 1. Moreover, the switch 9 can be switched via the PLC modem 4 and the microcontroller 6 by the central data acquisition device or another control device that is likewise not shown.

Other analog or digital process data (sensor data, for example 4-20 mA or 0-30 V signals) can be fed and/or analog or digital control signals (actuators, for example 4-20 mA or 0-30 V signals) can be output by electronic inputs and/or outputs 16, 17 on the circuit 5, on the microcontroller 6 or corresponding interface circuits (ex-isolators) that are not shown, and sockets on the housing.

Since the above-described system is integrated into a preferably commercially available plug or an only slightly modified plug 1, possible safety regulations are also satisfied in the additional use of the described system when the plug 1 in itself satisfies these safety regulations.

In the power line network that is shown in FIG. 2, there is a central data acquisition device 10 as network master, and it is connected to slaves 11, 12, 13 via power line communication. The slaves 11, 12, 13, as described in FIG. 1, have PLC modems and a network address that identifies it in the network. Depending on the power of the units or consumers, which are labeled 8, 14 and 15 in FIG. 2, in general at higher powers they are connected to the evaluation electronics either via terminals in a switchbox or distribution box or, generally at lower powers, via a connecting device 1 according to the invention.

The described detection of the state of units according to the invention is limited not only to the drilling process, but also to the following production phase on the drill hole. As soon as the drill holes have an external voltage supply, a central data acquisition by means of power line communication can detect the data of the distributed drill holes or can actuate actuators. The prerequisite for this is that the distributed measurement data acquisitions and the central data evaluation are in the same supply network 3. PLC enables communication within a radius of several kilometers, extremely simple installation being possible via the connecting device according to the invention if necessary.

The connecting device according to the invention, however, can be made not only as a plug or socket. For example, it is also possible to make it as a coupling, which is plugged or connected between plugs and socket or receptacles, as a result of which conventional plugs and sockets or receptacles that need not be modified can be used.

Depending on the embodiment, the invention yields one or more of the advantages that are mentioned below:
An economically advantageous installation is enabled by the ease of installation or of retrofitting of the system (couplings, plugs).
Corresponding housing variants are available for different ambient conditions.
By using PLC modulation, separate cabling for data communications is not necessary. In this way, costs for cabling and installation are reduced.
Repeaters are not necessary for the desired transmission distances (a few kilometers). This yields lower installation and operating costs. The reliability is increased.
The acquisition of data or the remote control of units that have not been detected to date enables a series of new applications (for example, distributed energy management, distributed state detection, process analysis).
Simple and flexible installation and de-installation by plugging the coupling into the power supply line in the vicinity of the unit.

1. Connecting device for connecting electrical power supply lines (3) of drilling and production facilities, characterized in that the connecting device (1) has a connection (4a) for the feed of electrical signals that represent the operating state of a device (8, 14, 15) into the power supply line (3).

2. Connecting device according to claim 1, wherein the connection (4a) is provided on a modem (4), especially a PLC modem.

3. Connecting device according to claim 2, wherein the modem (4) is supplied with current from the power supply line (3).

4. Connecting device according to claim 1, wherein a central data acquisition device (10) is connected to the power supply line (3), preferably via a modem (4), especially a PLC modem.

5. Connecting device according to claim 2, wherein the modems (4) are interconnected in a bus topology.

6. Connecting device according to claim 2, wherein the modems (4) are connected to one another via a master-slave communication (10 to 13).

7. Connecting device according to claim 1, wherein the connection (4a) is made bidirectional.

8. Connecting device according to claim 1, wherein a microcontroller (6) is connected upstream or downstream from the connection (4a), especially the modem (4).

9. Connecting device according to claim 1, wherein a measurement device (5) for an operating state is connected upstream from the connection (4a), especially the modem (4).

10. Connecting device according to claim 9, wherein the measurement device (5) measures values of the power supply line (3).

11. Connecting device according to claim 8, wherein the measurement device (5) and/or the microcontroller (6) has at least one external connection (16, 17), via which measured values or data from measurement devices or sensors that represent operating states or data of the consumer or his vicinity can be fed.

12. Connecting device according to claim 8, wherein the measurement device (5) and/or the microcontroller (6) has at least one external connection (16, 17) via which units of the installation can be controlled.

13. Connecting device according to claim 1, wherein it is a plug (1), a socket (2), a coupling or the like.

14. Connecting device according to claim 13, wherein the modem (4) and/or the microcontroller (6) and/or the measurement device (5) is/are integrated into the housing of the plug (1), the socket (2), the coupling or the like.
